(19) United States
(12) Patent Application Publication
(10) Pub. No.: US 2013/0208419 A1
(43) Pub. Date: Aug. 15, 2013

(54) TEMPERATURE CONTROL SYSTEM

(71) Applicants: HONG FU JIN PRECISION INDUSTRY (ShenZhen) CO., LTD., (US); HON HAI PRECISION INDUSTRY CO., LTD., (US)

(72) Inventor: JIE LI, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/756,408

(22) Filed: Jan. 31, 2013

(30) Foreign Application Priority Data
Feb. 10, 2012 (CN) 201210029561.5

(51) Int. Cl. G06F 1/20

(52) U.S. Cl. CPC G06F 1/206
USPC 361/679.48

(57) ABSTRACT

A temperature control system includes a motherboard, a first fan to cool the motherboard, and a baseboard management controller (BMC) connected to the first fan. The motherboard includes a front end area including a first temperature sensor, and a rear end area including a second temperature sensor. The BMC is connected to the first temperature sensor to receive a first temperature sensed by the first temperature sensor, and connected to the second temperature sensor to receive a second temperature sensed by the second temperature sensor. When the first temperature is more than the second temperature, the BMC controls rotational speed of the first fan according to the first temperature. When the second temperature is more than the first temperature, the BMC controls rotational speed of the first fan according to the second temperature.

### BACKGROUND

1. Technical Field

The present disclosure relates to a temperature control system.

2. Description of Related Art

Most servers employ fans to blow air across motherboards of the servers to cool the motherboards. However, this allows the side of the motherboard closest to the fans to cool faster than the side away from the fans. This leads to unequal cooling and can be detrimental to the life-span of the motherboard. Therefore, there is room for improvement in the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a block diagram of a temperature control system in accordance with an embodiment of the present disclosure.

FIG. 2 is a schematic connection diagram of the temperature control system of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references can mean “at least one”.

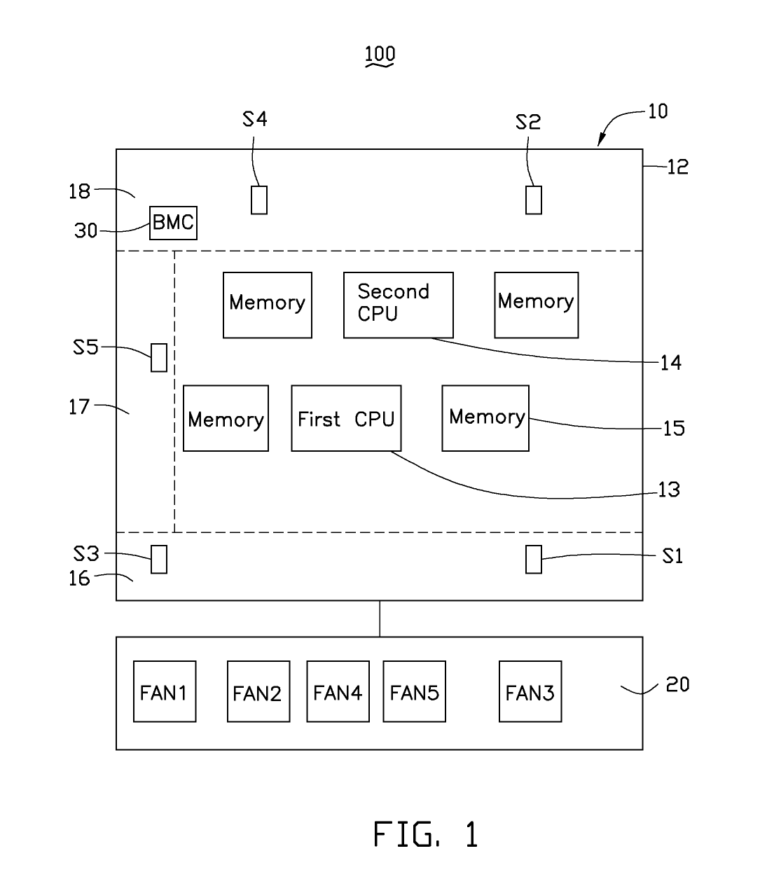

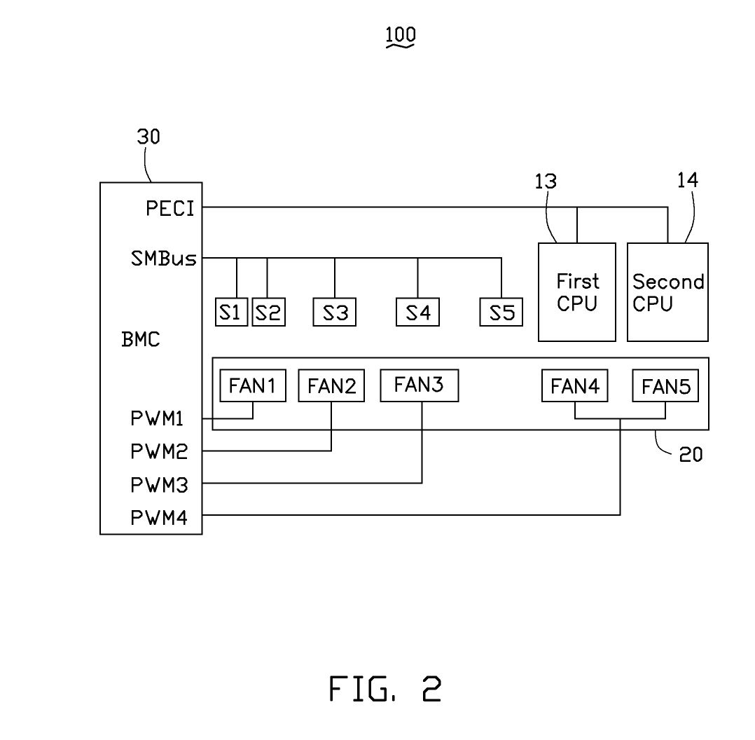

FIGS. 1 and 2 show an embodiment of a temperature control system 100. The temperature control system 100 includes a motherboard 10, a cooling module 20, and a baseboard management controller (BMC) 30 positioned on the motherboard 10 and connected to the cooling module 20. In the embodiment, the temperature control system 100 is applied in a server.

The motherboard 10 includes a circuit board 12, a first central processing unit (CPU) 13, a second CPU 14, a plurality of memories 15, and a group of sensors. The circuit board 12 includes a front end area 16, a rear end area 18, and an intermediate area 17 located between the front end area 16 and the rear end area 18. The first CPU 13, the second CPU 14, and the memories 15 are positioned in the intermediate area 17. In the embodiment, the BMC 30 is positioned in the rear end area 18. In other embodiments, the BMC 30 may be positioned in the intermediate area 17 or the front end area 16.

In the embodiment, the group of sensors includes a first temperature sensor S1, a second temperature sensor S2, a third temperature sensor S3, a fourth temperature sensor S4, and a fifth temperature sensor S5. The first temperature sensor S1 and the third temperature sensor S3 are positioned in two opposite ends of the front end area 16, to sense a temperature of the front end area 16. The second temperature sensor S2 and the fourth temperature sensor S4 are positioned in two opposite ends of the rear end area 18, to sense a temperature of the rear end area 18. The first temperature sensor S1 substantially aligns with the second temperature sensor S2. The fifth temperature sensor S5 is positioned in the intermediate area 17, to sense a temperature of the intermediate area 17.

In the embodiment, the cooling module 20 includes a first fan FAN1, a second fan FAN2, a third fan FAN3, a fourth fan FAN4, and a fifth fan FAN5. The first fan FAN1 substantially aligns with the first temperature sensor S1. The second fan FAN2 substantially aligns with the third temperature sensor S3. The third fan FAN3 substantially aligns with the fourth temperature sensor S4. The fourth fan FAN4 substantially aligns with the first CPU 13. The fifth fan FANS substantially aligns with the second CPU 14.

The BMC 30 includes a platform environment control interface PECI, a system management bus interface SMBus, and four pulse width modulation interfaces PWM1, PWM2, PWM3, PWM4. The platform environment control interface PECI is connected to the first CPU 13 and the second CPU 14, to receive overheating signals from the first CPU 13 and the second CPU 14. The system management bus interface SMBus is connected to the first temperature sensor S1 to receive a first temperature sensed by the first temperature sensor S1, through an inter-integrated circuit (I2C) bus. The system management bus interface SMBus is connected to the second temperature sensor S2 to receive a second temperature sensed by the second temperature sensor S2 through the I2C bus. The system management bus interface SMBus is connected to the third temperature sensor S3 to receive a third temperature sensed by the third temperature sensor S3 through the I2C bus. The system management bus interface SMBus is connected to the fourth temperature sensor S4 to receive a fourth temperature sensed by the fourth temperature sensor S4 through the I2C bus. The system management bus interface SMBus is connected to the fifth temperature sensor S5 to receive a fifth temperature sensed by the fifth temperature sensor S5 through the I2C bus. The pulse width modulation interface PWM1 is connected to the first fan FAN1, to output a first pulse signal to the first fan FAN1, to control rotational speed of the first fan FAN1. The pulse width modulation interface PWM2 is connected to the second fan FAN2, to output a second pulse signal to the second fan FAN2, to control rotational speed of the second fan FAN2. The pulse width modulation interface PWM3 is connected to the third fan FAN3, to output a third pulse signal to the third fan FAN3, to control rotational speed of the third fan FAN3. The pulse width modulation interface PWM4 is connected to the fourth fan FAN4 and the fifth fan FANS, to output a fourth pulse signal to the fourth fan FAN4 and the fifth fan FANS, to control rotational speed of the fourth fan FAN4 and the fifth fan FAN5.

The BMC 30 controls rotational speed of the first fan FAN1, the second fan FAN2, the third fan FAN3, the fourth fan FAN4, and the fifth fan FANS according to temperatures sensed by the first temperature sensor S1, the second temperature sensor S2, the third temperature sensor S3, the fourth temperature sensor S4, and the fifth temperature sensor S5, respectively. The BMC 30 further controls the fourth fan FAN4 and the fifth fan FANS to accelerate rotational speed when the BMC 30 receives the overheating signal from at least one of the first CPU 13 and the second CPU 14. It is may be understood that, the BMC 30 adjusts duty cycles of the first to fourth pulse signals outputted by the pulse width modulation interfaces PWM1-PWM4, and rotational speed of the first fan FAN1, the second fan FAN2, the third fan FAN3, the fourth fan FAN4, and the fifth fan FANS are adjusted accordingly.

In the embodiment, the temperature control system 100 includes a first cooling mode and a second cooling mode. In the first cooling mode, fan blades of the first fan FAN1, the second fan FAN2, the third fan FAN3, the fourth fan FAN4, and the fifth fan FANS rotate in a clockwise direction, to blow air across the motherboard 10 in a first direction. The front end area 16 functions as an air inlet of the motherboard 10, and the rear end area 18 functions as an air outlet of the motherboard 10. That is, air flows into the motherboard 10 from the front end area 16, and flows away from the motherboard 10 from the rear end area 18. In the second cooling mode, fan blades of the first fan FAN1, the second fan FAN2, the third fan FAN3, the fourth fan FAN4, and the fifth fan FAN5 rotate in an anticlockwise direction, to sucks air across the motherboard 10 in a second direction opposite to the first direction. The rear end area 18 functions as an air inlet of the motherboard 10, and the front end area 16 functions as an air outlet of the motherboard 10. That is, air flows into the motherboard 10 from the rear end area 18, and flows away from the motherboard 10 from the front end area 16.

In operation, the first temperature sensor S1 and the third temperature sensor S3 sense temperature of the front end area 16, and output the sensed temperature to the BMC 30. The second temperature sensor S2 and the fourth temperature sensor S4 sense temperature of the rear end area 18, and output the sensed temperature to the BMC 30. The fifth temperature sensor S5 senses temperature of the intermediate area 17, and outputs the sensed temperature to the BMC 30. The BMC 30 compares the first temperature sensed by the first temperature sensor S1 with the second temperature sensed by the second temperature sensor S2, and compares the third temperature sensed by the third temperature sensor S3 with the fourth temperature sensed by the fourth temperature sensor S4. If the first temperature is more than the second temperature, and the third temperature is more than the fourth temperature, the BMC 30 determines that the temperature control system 100 is in the second cooling mode. The BMC 30 adjusts duty cycle of the first pulse signal according to the first temperature, to adjust rotational speed of the first fan FAN1, and adjusts duty cycle of the second and the third pulse signals according to the third temperature, to adjust rotational speed of the second fan FAN2 and the third fan FAN3.

If the second temperature is more than the first temperature, and the fourth temperature is more than the third temperature, the BMC 30 determines that the temperature control system 100 is in the first cooling mode. The BMC 30 adjusts duty cycle of the first pulse signal according to the second temperature, to adjust rotational speed of the first fan FAN1, and adjusts duty cycle of the third pulse signal according to the fourth temperature, to adjust rotational speed of the third fan FAN3.

When the BMC 30 receives the overheat signal from at least one of the first CPU 13 and the second CPU 14, the BMC 30 adjusts duty cycle of the fourth pulse signal, to control the fourth fan FAN4 and the fifth fan FAN5 to accelerate rotational speed.

As detailed above, the BMC 30 can determine the temperature control system 100 is in the first cooling mode or the second cooling mode. In the first cooling mode, the BMC 30 adjusts rotational speed of the first fan FAN1 according to the second temperature sensed by the second temperature sensor S2, and adjusts rotational speed of the third fan FAN3 according to the fourth temperature sensed by the fourth temperature sensor S4. In the second cooling mode, the BMC 30 adjusts rotational speed of the first fan FAN1 according to the first temperature sensed by the first temperature sensor S1, and adjusts rotational speed of the second fan FAN2 and the third fan FAN3 according to the third temperature sensed by the third temperature sensor S3. Therefore, temperature of the motherboard 10 can be better controlled.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A temperature control system, comprising:
a motherboard comprising:
a front end area comprising a first temperature sensor; and
a rear end area comprising a second temperature sensor;
a cooling module comprising a first fan; and
a baseboard management controller (BMC) is connected to the first temperature sensor to receive a first temperature sensed by the first temperature sensor, connected to the second temperature sensor to receive a second temperature sensed by the second temperature sensor, and connected to the first fan;
wherein the BMC compares the first temperature with the second temperature;
wherein the BMC determines that the cooling module blows air across the motherboard, air flows into the motherboard from the front end area and flows away from the motherboard from the rear end area, and the BMC controls rotational speed of the first fan according to the second temperature, in response to the second temperature being more than the first temperature; and
wherein the BMC determines that the cooling module sucks air across the motherboard, air flows into the motherboard from the rear end area and flows away from the motherboard from the front end area, and the BMC controls rotational speed of the first fan according to the first temperature, in response to the first temperature being more than the second temperature.

2. The temperature control system of claim 1, wherein the BMC comprises:
a system management bus interface connected to the first temperature sensor to receive the first temperature, and connected to the second temperature sensor to receive the second temperature; and
a first pulse width modulation interface connected to the first fan, to output a first pulse signal to the first fan, to control rotational speed of the first fan;
wherein the BMC adjusts duty cycle of the first pulse signal according to the first temperature, to adjust rotational speed of the first fan, in response to the first temperature being more than the second temperature; and
wherein the BMC adjusts the duty cycle of the first pulse signal according to the second temperature, to adjust rotational speed of the first fan, in response to the second temperature being more than the first temperature.

3. The temperature control system of claim 2, wherein the first sensor substantially aligns with the second sensor, and substantially aligns with the first fan.

4. The temperature control system of claim 3, wherein the front end area further comprises a third temperature sensor, the rear end area further comprises a fourth temperature sensor, and the cooling module further comprises a second fan and a third fan connected to the BMC;
wherein the BMC is connected to the third temperature sensor to receive a third temperature sensed by the third temperature sensor, and connected to the fourth temperature sensor to receive a fourth temperature sensed by the fourth temperature sensor;
wherein the BMC compares the third temperature with the fourth temperature;
wherein the BMC controls rotational speed of the first fan according to the first temperature, and controls rotational speed of the second fan and the third fan according to the third temperature, in response to the first temperature being more than the second temperature, and the third temperature being more than the fourth temperature; and
wherein the BMC controls rotational speed of the first fan according to the second temperature, and controls rotational speed of the third fan according to the fourth temperature, in response to the second temperature being more than the first temperature, and the fourth temperature being more than the third temperature.

5. The temperature control system of claim 4, wherein the BMC further comprises:
a second pulse width modulation interface connected to the second fan, to output a second pulse signal to the second fan, to control rotational speed of the second fan; and
a third pulse width modulation interface connected to the third fan, to output a third pulse signal to the third fan, to control rotational speed of the third fan;
wherein the system management bus interface is connected to the third temperature sensor to receive the third temperature, and connected to the fourth temperature sensor to receive the fourth temperature;
wherein the BMC adjusts duty cycle of the second pulse signal and the third pulse signal according to the third temperature, to control rotational speed of the second fan and the third fan, in response to the first temperature being more than the second temperature, and the third temperature being more than the fourth temperature; and
wherein the BMC adjusts duty cycle of the third pulse signal according to the fourth temperature, to adjust rotational speed of the third fan, in response to the second temperature being more than the first temperature, and the fourth temperature being more than the third temperature.

6. The temperature control system of claim 5, wherein the second fan substantially aligns with the third sensor, and the third fan substantially aligns with the fourth sensor.

7. The temperature control system of claim 6, wherein the motherboard further comprises an intermediate area located between the front end area and the rear end area, the intermediate area comprises a first central processing unit (CPU) connected to the BMC, a second CPU connected to the BMC, and a plurality of memories, the cooling module further comprises a fourth fan and a fifth fan connected to the BMC;
wherein the BMC controls the fourth fan and the fifth fan to accelerate rotational speed, in response to the BMC receiving an overheat signal from at least one of the first CPU and the second first CPU.

8. The temperature control system of claim 7, wherein the fourth fan substantially aligns with the first CPU, and the fifth fan substantially aligns with the second CPU.

9. The temperature control system of claim 8, wherein the BMC further comprises:
a platform environment control interface connected to the first CPU and the second CPU to receive the overheat signal from the at least one of the first CPU and the second CPU; and
a fourth pulse width modulation interface connected to the fourth fan and the fifth fan, to output a fourth pulse signal to the fourth fan and the fifth fan, to control rotational speed of the fourth fan and the fifth fan;
wherein the BMC adjusts duty cycle of the fourth pulse signal to adjust rotational speed of the fourth fan and the fifth fan.
